(19) United States
(12) Patent Application Publication
(10) Pub. No.: US 2025/0035237 A1
(43) Pub. Date: Jan. 30, 2025

(54) CABLE TIE DEVICE

(71) Applicant: Dale Baker, Decatur, IL (US)

(72) Inventor: Dale Baker, Decatur, IL (US)

(21) Appl. No.: 18/472,610

(22) Filed: Sep. 22, 2023

Related U.S. Application Data
(60) Provisional application No. 63/515,208, filed on Jul. 24, 2023.

(51) Int. Cl. F16L 3/233

(52) U.S. Cl. CPC F16L 3/2332

(57) ABSTRACT

A cable tie device is provided. The device is comprised of a body with a first surface with at least one protrusion, wherein a first end of the body can be placed into a first opening of a connector and wherein the first end is secured by a protrusion of the first opening which engages the protrusion of the first surface. Then, the body can be placed around a plurality of items such that the second end of the body can then be secured within a second opening of the connector after being pulled through the opening to tighten the body around the items. Then, a heat source can be applied to the body to heat-shrink the body around the specific shape/contour of the items to prevent all movement of the items when bound by the body.

### CROSS-REFERENCE TO RELATED APPLICATION

The present application claims priority to, and the benefit of, U.S. Provisional Application No. 63/515,208, which was filed on Jul. 24, 2023, and is incorporated herein by reference in its entirety.

### FIELD OF THE INVENTION

The present invention relates generally to the field of cable ties. More specifically, the present invention relates to a cable tie device comprised of a heat-shrinkable cable tie with a continuous body that can be cut-to-fit, and that can be attached around a plurality of items via a connector. Accordingly, the present disclosure makes specific reference thereto. Nonetheless, it is to be appreciated that aspects of the present invention are also equally applicable to other like applications, devices, and methods of manufacture.

### BACKGROUND

Plastic cable ties are a versatile fastening solution. Cable ties can be used to securely bind diverse objects and materials together. These convenient fasteners find their utility across a spectrum of applications, ranging from organizing cables and wires with meticulous precision to bundling objects for efficient storage. Despite their widespread use, the effectiveness of plastic cable ties in immobilizing items might be compromised in certain scenarios. While these ties excel in many instances, situations may arise where their tightening mechanism falls short of entirely arresting the movement of an item, potentially leading to challenges in maintaining desired levels of stability and security during transport and storage. In addition, an individual must purchase plastic cable ties in desired lengths. If the cable ties are then not long enough, the individual must purchase larger cable ties or attempt to daisy-chain multiple cable ties together, neither of which is desirable.

Therefore, there exists a long-felt need in the art for an improved cable tie. More specifically, there exists a long-felt need in the art for a cable tie device that more adequately secures items the device binds together. In addition, there exists a long-felt need in the art for a cable tie device that can be customized in length to fit specific binding applications.

The subject matter disclosed and claimed herein, in one embodiment thereof, comprises a cable tie device. The device is comprised of a body with a first surface with at least one protrusion. A first end of the body can be placed into a first opening of a connector, wherein the first end is secured by a protrusion of the first opening which engages the protrusion of the first surface. Then, the body (which can be cut to fit) can be placed around a plurality of items such that the second end of the body can then be secured within a second opening of the connector (also by a protrusion of the second opening which engages the protrusion of the first surface) after being pulled through the opening to tighten the body around the items. Then, a heat source can be applied to the body to heat-shrink the body around the specific shape/contour of the items to prevent all movement of the items when bound by the body.

In this manner, the cable tie device of the present invention accomplishes all the foregoing objectives and provides an improved cable tie. More specifically, the heat-shrinking ability of the device ensures that the items the device binds together are adequately secured and cannot move during transport/storage. In addition, the device can be customized in length to fit specific binding applications by the body of the device being stored in a continuous, rolled configuration.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cable tie device comprised of a cable tie that can be used to secure various objects together during transport, storage, etc. The device is comprised of a body with a first surface with at least one protrusion which can be inserted and locked into a connector with at least one opening with at least one protrusion. The body of the device is preferably made from a heat-shrinkable plastic material. Unlike existing cable ties known in the art, the heat-shrink ability of the body allows the device to tightly secure the objects the body surrounds by molding to the exact shape/contour of the objects.

A first surface of the body is comprised of at least one protrusion. The first end of the body can be inserted into a first opening (or in another embodiment, a second opening) of at least one connector. Inside the opening, at least one protrusion is positioned on a top wall of the opening and extends downwards away from the top wall. In this manner, the protrusion of the opening engages the protrusion of the first surface when the first end of the body is inserted into the opening. Once the protrusion of the opening has engaged the protrusion of the first surface, the body cannot be removed from the connector.

Then, the remainder of the body can be wrapped around at least one object. Once around the object, the second end of the body can be inserted into a second opening (or in another embodiment, the first opening) of the connector, which is preferably positioned below the second opening. Inside the opening, at least one protrusion is positioned on a top wall of the opening and extends downwards away from the top wall. In this manner, the protrusion engages the protrusion of the opening engages the protrusion of the first surface when the first end of the body is inserted into the opening. Once the protrusion of the opening has engaged the protrusion of the first surface, the body cannot be removed from the connector, but can be pulled through the opening to completely tighten the body around the object and secure the body in said tightened position within the connector. Then, the body can be heated such that it heat-shrinks around the object, preventing any movement of the object.

The present invention is also comprised of a method of using the device. First, a device is provided comprised of a body with a first surface comprised of at least one protrusion, and at least one connector comprised of at least one opening having at least one protrusion. Then, the first end of the body can be inserted into a first opening (or in an alternative embodiment, the second opening) of the connector such that a protrusion of the first opening engages the protrusion of the first surface and prevents the first end from being removed from the first opening. Then, the body can be wrapped around at least one object. Next, the second end of the body can be inserted into a second opening (or in an alternative embodiment, the first opening) of the connector, wherein the second end can be pulled through the opening until the body is tight around the object(s). When this occurs, a protrusion of the second opening engages the protrusion of the first surface and prevents the second end from being removed from the second opening, thus preventing the body from loosening around the object(s). Finally, heat can be applied to the body such that the body heat shrinks around the object.

Accordingly, the cable tie device of the present invention is particularly advantageous as it provides an improved cable tie with a heat-shrinking ability that ensures that the items the device binds together are adequately secured and cannot move during transport/storage. In addition, the device can be customized in length to fit specific binding applications by the body of the device being stored in a continuous, rolled configuration. In this manner, the cable tie device overcomes the limitations of existing cable ties known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a body of one potential embodiment of a cable tie device of the present invention in accordance with the disclosed architecture;

FIG. 2 illustrates a perspective view of one potential embodiment of a cable tie device of the present invention while secured around a number of objects in accordance with the disclosed architecture;

FIG. 3 illustrates a perspective view of one potential embodiment of a cable tie device of the present invention while secured around a number of objects in accordance with the disclosed architecture;

FIG. 4 illustrates a front view of one potential embodiment of a cable tie device of the present invention while secured around a number of objects in accordance with the disclosed architecture;

FIG. 5 illustrates a front view of one potential embodiment of a cable tie device of the present invention while secured around a number of objects in accordance with the disclosed architecture; and

FIG. 6 illustrates a flowchart of a method of using one potential embodiment of a cable tie device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cable tic. More specifically, there exists a long-felt need in the art for a cable tie device that more adequately secures items the device binds together. In addition, there exists a long-felt need in the art for a cable tie device that can be customized in length to fit specific binding applications.

The present invention, in one exemplary embodiment, is comprised of a cable tie device comprised of a body with a first surface with at least one protrusion which can be inserted and locked into a connector with at least one opening with at least one protrusion. The body of the device is preferably made from a heat-shrinkable plastic material such that the body can be heated and tightly secure the objects the body surrounds by molding to the exact shape/contour of the objects.

A first surface of the body is comprised of at least one protrusion. The first end of the body can be inserted into a first opening (or in another embodiment, a second opening) of at least one connector. Inside the opening, at least one protrusion is positioned on a top wall of the opening and extends downwards away from the top wall. In this manner, the protrusion of the opening engages the protrusion of the first surface when the first end of the body is inserted into the opening. Once the protrusion of the opening has engaged the protrusion of the first surface, the body cannot be removed from the connector.

Then, the remainder of the body can be wrapped around at least one object. Once around the object, the second end of the body can be inserted into a second opening (or in another embodiment, the first opening) of the connector, which is preferably positioned below the second opening. Inside the opening, at least one protrusion is positioned on a top wall of the opening and extends downwards away from the top wall. In this manner, the protrusion engages the protrusion of the opening engages the protrusion of the first surface when the first end of the body is inserted into the opening. Once the protrusion of the opening has engaged the protrusion of the first surface, the body cannot be removed from the connector, but can be pulled through the opening to completely tighten the body around the object and secure the body in said tightened position within the connector. Then, the body can be heated such that it heat-shrinks around the object, preventing any movement of the object.

The present invention is also comprised of a method of using the device. First, a device is provided comprised of a body with a first surface comprised of at least one protrusion, and at least one connector comprised of at least one opening having at least one protrusion. Then, the first end of the body can be inserted into a first opening (or in an alternative embodiment, the second opening) of the connector such that a protrusion of the first opening engages the protrusion of the first surface and prevents the first end from being removed from the first opening. Then, the body can be wrapped around at least one object. Next, the second of the body can be inserted into a second opening (or in an alternative embodiment, the first opening) of the connector, wherein the second end can be pulled through the opening until the body is tight around the object(s). When this occurs, a protrusion of the second opening engages the protrusion of the first surface and prevents the second end from being removed from the second opening, thus preventing the body from loosening around the object(s). Finally, heat can be applied to the body such that the body heat shrinks around the object.

Accordingly, the cable tie device of the present invention is particularly advantageous as it provides an improved cable tie with a heat-shrinking ability that ensures that the items the device binds together are adequately secured and cannot move during transport/storage. In addition, the device can be customized in length to fit specific binding applications by the body of the device being stored in a continuous, rolled configuration. In this manner, the cable tie device overcomes the limitations of existing cable ties known in the art.

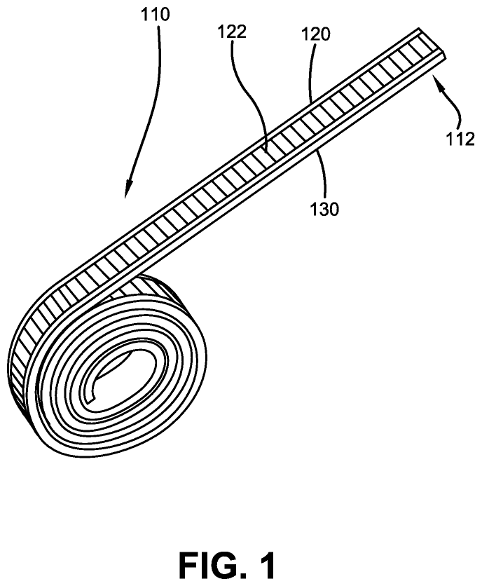

Referring initially to the drawings, FIG. 1 illustrates a perspective view of a body 110 of one potential embodiment of a cable tie device 100 of the present invention in accordance with the disclosed architecture. The device 100 is comprised of a cable tie that can be used to secure various objects 10 together during transport, storage, etc. The device 100 is comprised of a body 110 with a first surface 120 with at least one protrusion 122 which can be inserted and locked into a connector 140 with at least one opening 150 with at least one protrusion 152.

The body 110 of the device 100 is preferably rectangular in shape. The body 110 is also preferably made from a plastic material. More specifically, the body 110 is made from a heat-shrinkable plastic material. This material may include, but is not limited to, PVC, polyolefin, polyethylene, etc. Unlike existing cable ties known in the art, the heat-shrink ability of the body 110 allows the device 100 to tightly secure the objects 10 the body 110 surrounds, by molding to the exact shape/contour of the objects 10.

A first surface 120 of the body 110 is comprised of at least one protrusion 122. The protrusion may be in the form of a serration, a tooth, or an angled member that extends upwards from the first surface 120. The second surface 130 is preferably smooth.

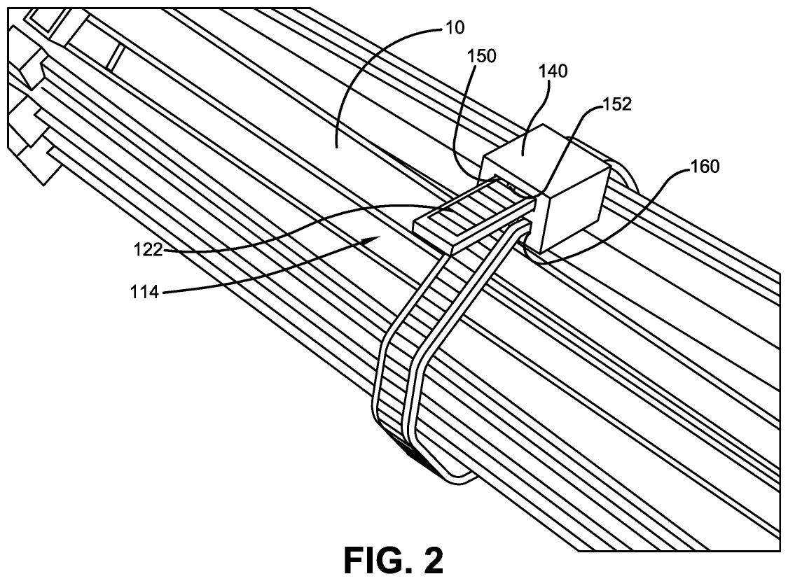

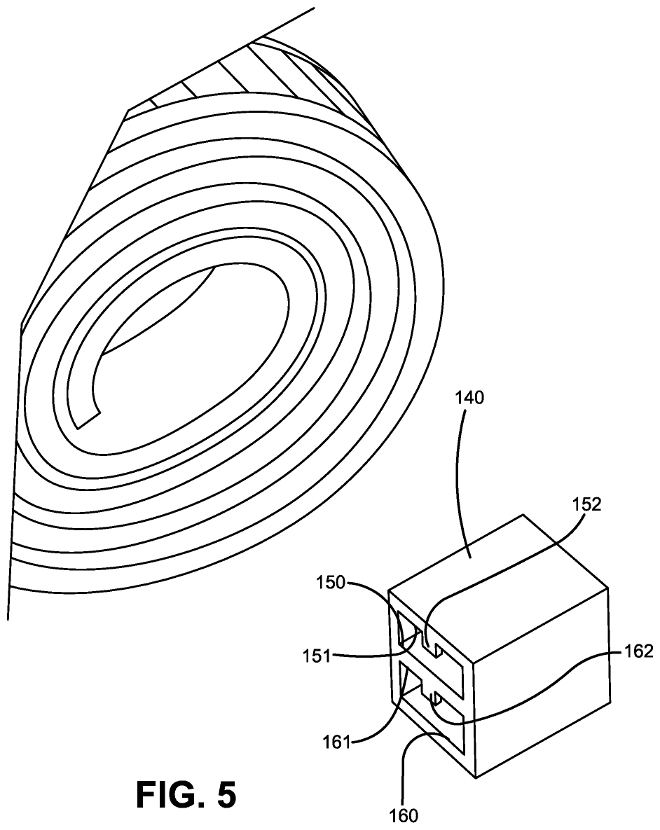

The first end 112 of the body 110 can be inserted into a first opening 150 (or in another embodiment, a second opening 160, as seen in FIG. 2) of at least one connector 140. The connector 140 may be any shape but is preferably generally square. The connector 140 is comprised of at least one opening 150. Inside the opening 150, at least one protrusion 152 is positioned on a top wall 151 of the opening 150. The protrusion 151 extends downwards away from the top wall 151, as seen in FIG. 5. In this manner, the protrusion 152 engages the protrusion 122 of the first surface 120 when the first end 112 of the body 110 is inserted into the opening 150. The protrusion 152 may be, but is not limited to, a tongue, a channel, a serration, a tooth, etc., that directly opposes the protrusions 122 of the first surface 120. Once the protrusion 152 of the opening 150 has engaged the protrusion 122 of the first surface 120, the body 110 cannot be removed from the connector 140.

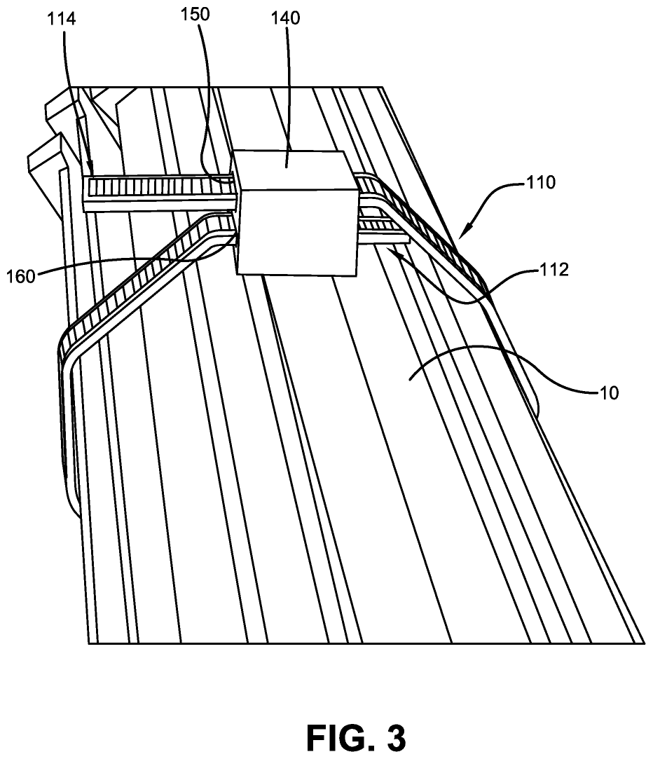

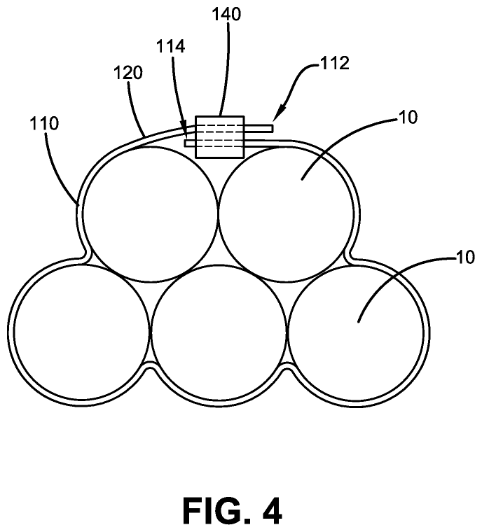

Then, the remainder of the body 110 can be wrapped around at least one object 10. Once around the object 10, the second end 114 of the body 110 can be inserted into a second opening 160 (or in another embodiment, the first opening 150, as seen in FIG. 3) of the connector 140, which is preferably positioned below the second opening 160. Inside the opening 160, at least one protrusion 162 is positioned on a top wall 161 of the opening 160. The protrusion 161 extends downwards away from the top wall 161. In this manner, the protrusion 162 engages the protrusion 122 of the first surface 120 when the first end 112 of the body 110 is inserted into the opening 160. The protrusion 162 may be, but is not limited to, a tongue, a channel, a serration, a tooth, etc., that directly opposes the protrusions 122 of the first surface 120. Once the protrusion 162 of the opening 160 has engaged the protrusion 122 of the first surface 120, the body 110 cannot be removed from the connector 140 but can be pulled through the opening 160 to completely tighten the body 110 around the object 10 and secure the body 110 in said tightened position within the connector 140. Then, the body 110 can be heated such that it heat-shrinks around the object, preventing any movement of the object 10, as seen in FIG. 4.

In the preferred embodiment, the body 110 is stored in a rolled configuration. In this manner, the body 110 can be cut to length during use. In addition, one embodiment of the connector 140 may feature multiple protrusions 152,162 in each opening 150,160 to allow multiple bodies 110 to be inserted into each opening 150,160 to increase the length of the body 110. The body 110 may be manufactured in different precut lengths, for example 6″ increments along with the rolls, but the invention is not so limited.

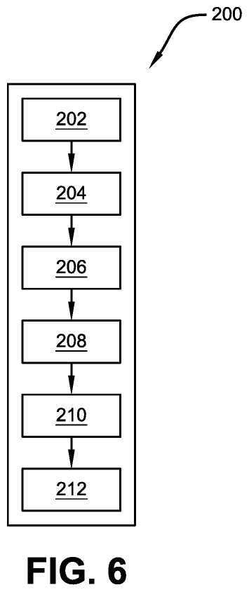

The present invention is also comprised of a method of using 200 the device 100, as seen in FIG. 6. First, a device 100 is provided comprised of a body 110 with a first surface 120 comprised of at least one protrusion 122, and at least one connector 140 comprised of at least one opening 150 having at least one protrusion [Step 202]. Then, the first end 112 of the body 110 can be inserted into a first opening 150 (or in an alternative embodiment, the second opening 160) of the connector 140 such that a protrusion 152 of the first opening 150 engages the protrusion 122 of the first surface 120 and prevents the first end 112 from being removed from the first opening 150 [Step 204]. Then, the body 110 can be wrapped around at least one object 10 [Step 206]. Next, the second end 114 of the body 110 can be inserted into a second opening 160 (or in an alternative embodiment, the first opening 150) of the connector 140, wherein the second end 114 can be pulled through the opening 160 until the body 110 is tight around the object(s) 10 [Step 208]. When this occurs, a protrusion 162 of the second opening 160 engages the protrusion 122 of the first surface 120 and prevents the second end 114 from being removed from the second opening 160, and thus prevents the body 110 from loosening around the object(s) 10 [Step 210]. Finally, heat can be applied to the body 110 such that the body 110 heat-shrinks around the object 10 [Step 212]. This ensures the body 110 contacts every surface/contour of the object(s) 10 and prevents the object(s) from moving.

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “cable tie device” and “device” are interchangeable and refer to the cable tie device 100 of the present invention.

Notwithstanding the foregoing, the cable tie device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the cable tie device 100 as shown in the FIGS. are for illustrative purposes only, and that many other sizes and shapes of the cable tie device 100 are well within the scope of the present disclosure. Although the dimensions of the cable tie device 100 are important design parameters for user convenience, the cable tie device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cable tie device comprising:
a body comprised of a first surface with a first protrusion;
a connector comprised of a first opening;
a second protrusion positioned within the first opening.

2. The cable tie device of claim 1, wherein the first protrusion is comprised of a serration, a tooth, or an angled member.

3. The cable tie device of claim 1, wherein the body is comprised of a heat-shrinkable material.

4. The cable tie device of claim 1, wherein a second surface of the body is comprised of a smooth surface.

5. A cable tie device comprising:
a body comprised of a first surface with a first protrusion;
a connector comprised of a first opening and a second opening;
a second protrusion positioned within the first opening; and
a third protrusion positioned within the second opening.

6. The cable tie device of claim 5, wherein the second protrusion is positioned on and extends away from a top wall of the first opening.

7. The cable tie device of claim 5, wherein the third protrusion is positioned on and extends away from a top wall of the second opening.

8. The cable tie device of claim 5, wherein the second protrusion is comprised of a tongue, a channel, a serration, or a tooth.

9. The cable tie device of claim 5, wherein the third protrusion is comprised of a tongue, a channel, a serration, or a tooth.

10. The cable tie device of claim 5, wherein the first protrusion is comprised of a serration, a tooth, or an angled member.

11. The cable tie device of claim 5, wherein a second surface of the body is comprised of a smooth surface.

12. The cable tie device of claim 5, wherein the body is comprised of a PVC, a polyolefin, or a polyethylene material.

13. A method of using a cable tie device, the method comprising the following steps:
providing a cable tie device comprised of body comprised of a first surface comprised of a first protrusion, and a connector comprised of a first opening comprised of a second protrusion and a second opening comprised of a third protrusion;
inserting a first end of the body into the second opening;
wrapping the body around an object;
inserting a second end of the body into the first opening; and
applying heat to the body.

14. The method of using a cable tie device of claim 13, wherein the first protrusion is comprised of a serration, a tooth, or an angled member.

15. The method of using a cable tie device of claim 13, wherein the body is comprised of a heat-shrinkable material.

16. The method of using a cable tie device of claim 13, wherein the heat-shrinkable material is comprised of a PVC, a polyolefin, or a polyethylene material.

17. The method of using a cable tie device of claim 13, wherein the second protrusion is comprised of a tongue, a channel, a serration, or a tooth.

18. The method of using a cable tie device of claim 13, wherein the third protrusion is comprised of a tongue, a channel, a serration, or a tooth.

19. The method of using a cable tie device of claim 13, wherein the first opening is positioned above the second opening on the connector.

20. The method of using a cable tie device of claim 13, wherein the body can be cut.
